(19) United States
(12) Patent Application Publication
(10) Pub. No.: US 2017/0123720 A1
(43) Pub. Date: May 4, 2017

(54) STORAGE DEVICE AND METHOD OF ESTIMATING PERFORMANCE OF STORAGE DEVICE

(71) Applicant: FUJITSU LIMITED, Kawasaki-shi (JP)

(72) Inventors: Kazuichi Oe, Yokohama (JP); TOSHIHARU MAKIDA, Numazu (JP); KIYOSHI SUGIOKA, Mishima (JP); Takeo Honda, Nagoya (JP)

(73) Assignee: FUJITSU LIMITED, Kawasaki-shi, (JP)

(21) Appl. No.: 15/334,994

(22) Filed: Oct. 26, 2016

(30) Foreign Application Priority Data
Nov. 2, 2015 (JP) 2015-215652

(51) Int. Cl. G06F 3/06

(52) U.S. Cl. CPC G06F 3/0653; G06F 3/0604; G06F 3/0683

(57) ABSTRACT

A storage device includes first and second memories and a processor. The processor is configured to calculate a second number of access times with respect to each of the first and second memories on basis of a first busy rate and a first number of access times with respect to each of the first and second memories at a predetermined timing. The first number of access times represents a number of access times per unit time. The second number of access times represents a maximum value of the number of access times per unit time. The processor is configured to estimate a third number of access times on basis of the first busy rate and the second number of access times of each of the first and second memories. The third number of access times represents a number of access times per unit time with respect to the storage device.

### CROSS-REFERENCE TO RELATED APPLICATION

This application is based upon and claims the benefit of priority of the prior Japanese Patent Application No. 2015-215652, filed on Nov. 2, 2015, the entire contents of which are incorporated herein by reference.

### FIELD

The embodiment discussed herein is related to a storage device and a method of estimating a performance of a storage device.

### BACKGROUND

A technology has been known which is capable of easily determining a system configuration of a storage device provided with a plurality of file servers or the like in consideration of data input/output (IO) performance.

When an access pattern of the IO (referred to simply as “user IO” hereinafter) from a user varies, the positions of data reading/writing with respect to the hard disk drives (HDDs) provided in file servers are changed. Accordingly, the overhead of the HDDs is changed, and a maximum value of the IO performance is also changed.

The “access pattern” indicates an access occurrence rate of accesses for each disk access size (referred to as an “IO size”) with respect to read and write disk accesses. In other words, the “access pattern” is information statistically representing the results obtained from measuring and analyzing the number of occurrence times of accesses for each IO size with respect to read and write disk accesses to a storage device during an actual operation of file servers. The “access pattern” may be referred to as a “workload”.

When a system configuration is implemented without considering the maximum value of the IO performance, disk accesses may be concentrated to some of the multiple HDDs provided in the file servers, thereby deteriorating the IO performance in the entire system. Hereinafter, the “maximum value of the IO performance” may be referred to as a “maximum IO performance”.

Accordingly, a system configuration of a storage device is determined by monitoring a relationship between an input/output per second (IOPS) and an IO busy rate (or simply referred to as a busy rate), and calculating a maximum IO performance at a current time on the basis of the result of the monitoring.

Related techniques are disclosed in, for example, Japanese Laid-Open Patent Publication No. 2013-171305, Japanese Laid-Open Patent Publication No. 2011-243043, Japanese Laid-Open Patent Publication No. 2013-164820, Japanese Laid-Open Patent Publication No. 2012-509538, and International Publication Pamphlet No. WO 2011/092738.

In the above-described technology, a system configuration of a storage device which includes, in addition to HDDs, memory devices (e.g., solid state drives (SSDs)) having a different performance characteristic from that of HDDs may not be implemented in consideration of the maximum IO performance. Thus, disk accesses may be concentrated to a portion of the multiple HDDs or SSDs provided in the file servers, thereby deteriorating the IO performance in the entire system.

### SUMMARY

According to an aspect of the present invention, provided is a storage device including a first memory, a second memory having a different performance characteristic from that of the first memory, and a processor coupled to the first and second memories. The processor is configured to calculate a second number of access times with respect to each of the first and second memories on basis of a first busy rate and a first number of access times with respect to each of the first and second memories. The first busy rate represents a busy rate at a predetermined timing. The first number of access times represents a number of access times per unit time at the predetermined timing. The second number of access times represents a maximum value of the number of access times per unit time. The processor is configured to estimate a third number of access times on basis of the first busy rate and the second number of access times of each of the first and second memories. The third number of access times represents a number of access times per unit time with respect to the storage device.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an exemplary functional configuration of a storage device according to an embodiment;

FIG. 2 is a diagram illustrating an exemplary storage volume configuration in a storage device according to an embodiment;

FIG. 3 is a diagram illustrating an exemplary process of estimating a performance in a storage device according to an embodiment;

FIG. 4 is a diagram illustrating an exemplary relationship between an IOPS and a busy rate in an HDD and an SSD provided in a storage device according to an embodiment; and

FIG. 5 is a flowchart illustrating an exemplary process of estimating a performance in a storage device according to an embodiment.

### DESCRIPTION OF EMBODIMENT

Hereinafter, an embodiment will be described with reference to the accompanying drawings. The embodiment described below is merely illustrative and is not intended to exclude various modifications and applications of techniques which are not specified in the embodiment. That is, the embodiment may be variously modified within a scope that does not depart from the gist of the embodiment.

Each of the drawings is not intended to include only the components illustrated therein and may include, for example, other functions.

In the drawings, since a similar reference numeral indicates a similar part, overlapping descriptions thereof will be omitted.

### Embodiment

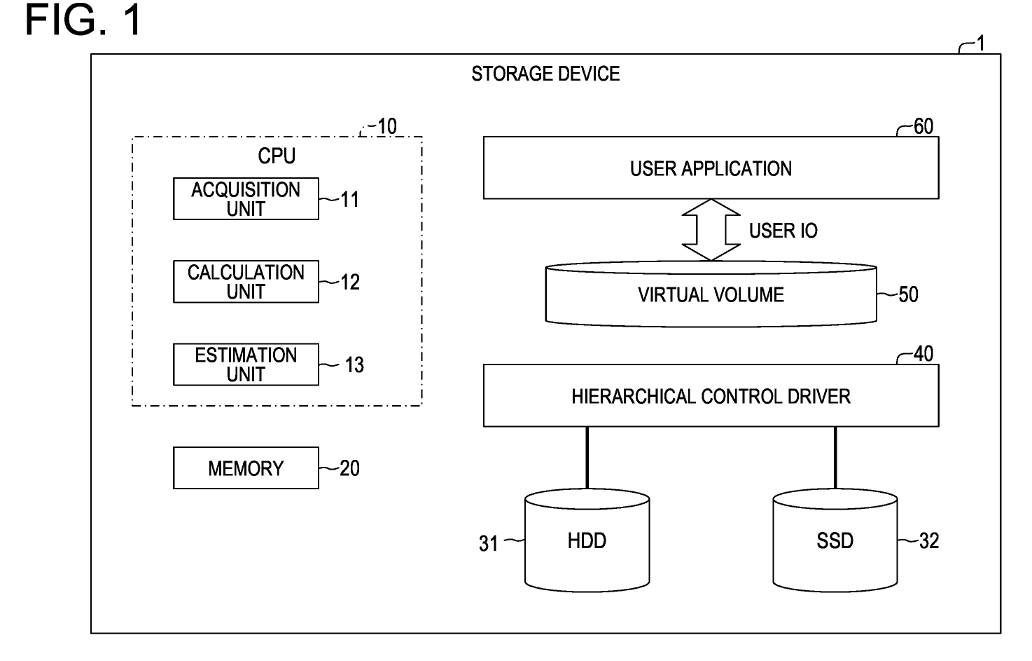

FIG. 1 is a diagram illustrating an exemplary functional configuration of a storage device 1 according to an embodiment.

The storage device 1 includes an HDD 31 and an SSD 32 to be described later and provides a memory area to a host device (not illustrated). The storage device 1 may save data in a distributed or redundant state in the HDD 31 and the SSD 32 by using, for example, a redundant array of inexpensive disks (RAID).

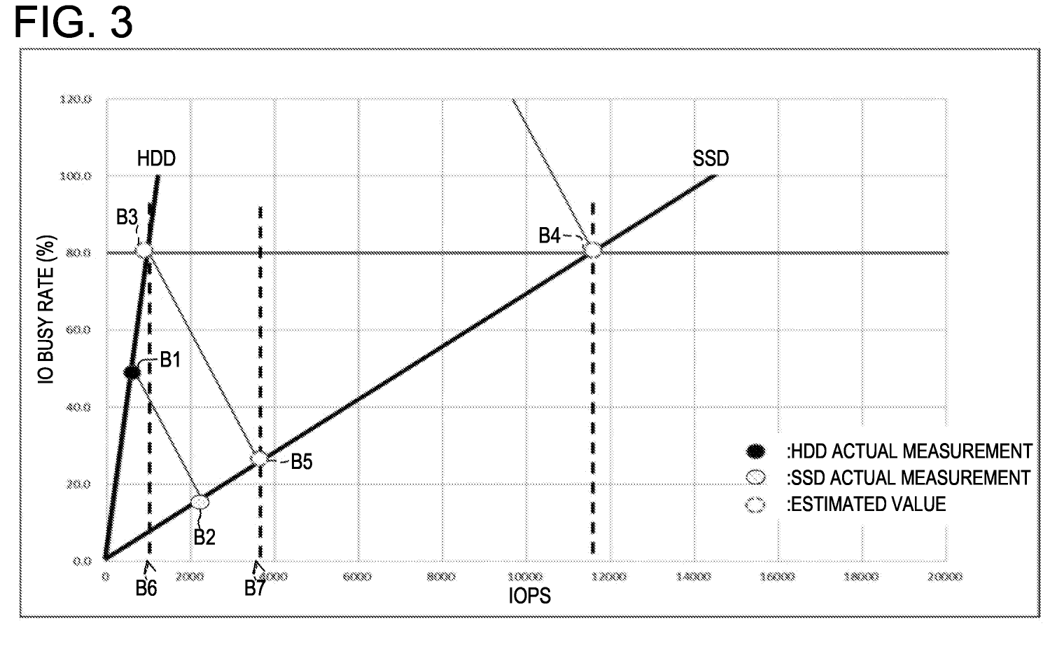

The storage device 1 estimates the IOPS thereof in its entirety on the basis of actual measurement values for IOPSs and busy rates of the HDD 31 and the SSD 32, and on the basis of a linear characteristic of the IOPSs and the busy rates. Details of the method of estimating the IOPS of the entire storage device 1 will be described later with reference to FIG. 3.

The storage device 1 may include a central processing unit (CPU) 10, a memory 20, the HDD 31, and the SSD 32. In addition, the storage device 1 may include a hierarchical control driver 40, a virtual volume 50, and a user application 60.

The HDD 31 and the SSD 32 are examples of memory devices in which data is stored to be readable and writable. The HDD 31 may have a different performance characteristic from that of the SSD 32. The “performance characteristic” may be referred to as a “performance value”, and, for example, is the IOPS or an access speed. In general, when the HDD 31 and the SSD 32 are used under similar conditions, the SSD 32 has a higher performance value (e.g., IOPS or an access speed) than that of the HDD 31. In addition, the memory capacity of the HDD 31 may be larger than the memory capacity of the SSD 32.

While FIG. 1 illustrates one HDD 31 and one SSD 32, the number of HDDs 31 and SSDs 32 are not limited thereto. The number of HDDs 31 and SSDs 32 provided in the storage device 1 may be variously modified. Hereinafter, the “HDD 31” and the “SSD 32” may be collectively referred to as “memory devices 31 and 32”. The “memory device” may be referred to as a “sub-pool”.

The hierarchical control driver 40 performs a hierarchical control of data to be stored in the memory devices 31 and 32. In other words, the hierarchical control driver 40 may control data with a high access frequency to be stored in the SSD 32 having high IOPS and a high access speed, and data with a low access frequency to be stored in the HDD 31 having low IOPS and a low access speed. That is, the hierarchical control driver 40 performs a control to distribute and store the occurring user IO in the HDD 31 and the SSD 32.

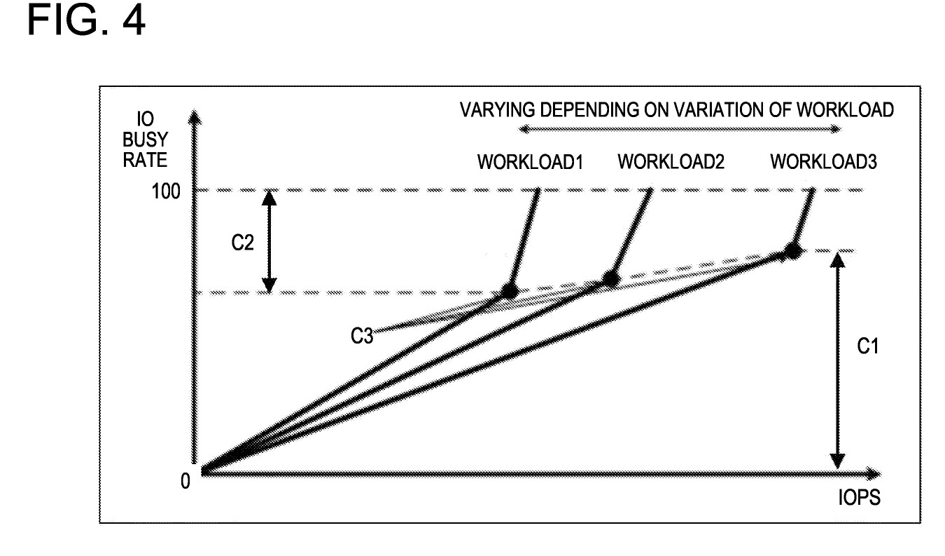

In addition, as described later with reference to FIG. 4, the hierarchical control driver 40 may periodically measure the IOPSs and busy rates of the memory devices 31 and 32.

The virtual volume 50 is a logical volume that may be recognized by a user. The “virtual volume” may be referred to as a “logical volume” or a “logical unit (LU)”.

The user application 60 is software having a function to execute, for example, a process for storing data. The user application 60 may issue a user IO for the virtual volume 50 on the basis of an input from a user. The “user application” may be a “virtual machine (VM)”.

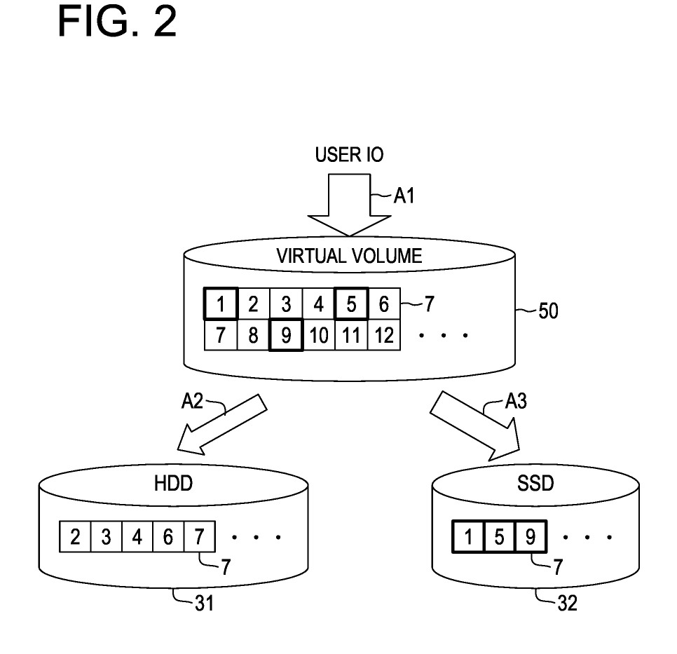

FIG. 2 is a diagram illustrating an exemplary storage volume configuration in the storage device 1 according to the embodiment.

The user application 60 may issue, for example, a user IO for writing data to the virtual volume 50 (A1). Accordingly, the data divided in units of sub-logical unit number (sub-LUN) 7, for example, a 1G byte or 256G bytes may be stored in the virtual volume 50. FIG. 2 represents an example where twelve sub-LUNs 7 identified by identifiers (ID) “1” to “12” are stored in the virtual volume 50.

The “sub-LUN” may be referred to as a “segment”. In FIG. 2, only a portion of the “sub-LUNs” are represented along with their reference numerals, and the reference numerals of other “sub-LUNs” are omitted.

The hierarchical control driver 40 may store, in the HDD 31, a portion of the sub-LUNs 7 stored in the virtual volume 50 (A2). FIG. 2 represents an example where, among the sub-LUNs 7 identified by IDs “1” to “12”, the sub-LUNs 7 identified by IDs “2” to “4”, “6”, and “7” are stored in the HDD 31.

The hierarchical control driver 40 may store, in the SSD 32, a portion of the sub-LUNs 7 stored in the virtual volume 50 (A3). FIG. 2 represents an example where, among the sub-LUNs 7 identified by IDs “1” to “12”, the sub-LUNs 7 identified by IDs “1”, “5”, and “9” are stored in the SSD 32. In the virtual volume 50 and the SSD 32 of FIG. 2, the sub-LUNs 7 to be stored in the SSD 32 are represented in bold frames.

The memory 20 is, for example, a memory device including a read-only memory (ROM) and a random access memory (RAM). In the ROM of the memory 20, programs such as a basic input/output system (BIOS), the hierarchical control driver 40, and the user application 60 may be recorded. The programs recorded in the memory 20 may be appropriately read by the CPU 10 so as to be executed. The RAM of the memory 20 may be used as a primary recording memory or a working memory.

The CPU 10 is a processor that performs various controls and arithmetic operations, and implements various functions by executing an operating system (OS) or programs (e.g., a performance estimation program according to the present embodiment) stored in the memory 20. That is, as illustrated in FIG. 1, the CPU 10 may function as an acquisition unit 11, a calculation unit 12, and an estimation unit 13. The CPU 10 may periodically estimate the performance of the entire storage device 1 by initiating the performance estimation program at regular time intervals.

The programs to implement the functions of the acquisition unit 11, the calculation unit 12, and the estimation unit 13 may be provided in a form recorded in a computer-readable recording medium such as a flexible disk, a compact disc (CD), e.g., CD-ROM, CD-R, and CD-RW, a digital versatile disc (DVD), e.g., DVD-ROM, DVD-RAM, DVD-R, DVD+R, DVD-RW, DVD+RW, and HD-DVD, a blue-ray disk, a magnetic disk, an optical disk, or a magneto-optical disk. The computer (e.g., the CPU 10 in the present embodiment) may read the programs from the above-described recording medium through a reading device (not illustrated) and transmit the programs to an internal or external memory device to store the programs therein and use the programs. The programs may be recorded in a memory device (a recording medium) such as a magnetic disk, an optical disk, or a magneto-optical disk and provided from the memory device to the computer via a communication path.

When implementing the functions as the acquisition unit 11, the calculation unit 12, and the estimation unit 13, the programs stored in the internal memory device (e.g., the memory 20 in the present embodiment) may be executed by the computer (e.g., the CPU 10 in the present embodiment). The programs recorded in the recording medium may be read and executed by the computer.

The CPU 10 controls the operation of the entire storage device 1. The device for controlling the operation of the entire storage device 1 is not limited to the CPU 10, and may be any one of, for example, a micro processing unit (MPU), a digital signal processor (DSP), an application specific integrated circuit (ASIC), a programmable logic device (PLD), and a field programmable gate array (FPGA). The device for controlling the operation of the entire storage device 1 may be a combination of two or more of the CPU, the MPU, the DSP, the ASIC, the PLD, and the FPGA.

The acquisition unit 11 acquires the IOPS and busy rate of the HDD 31 and the IOPS and busy rate of the SSD 32. All the IOPS and busy rate of the HDD 31 and the IOPS and busy rate of the SSD 32 may be obtained at the same timing.

The “IOPS” acquired by the acquisition unit 11 is an example of a “first number of access times” and represents the number of times of accesses to the memory devices 31 and 32 per unit time. The “busy rate” is a rate of a load allowable for each of the memory devices 31 and 32. The “busy rate” may be referred to as “% util”.

The acquisition unit 11 may periodically acquire the IOPSs and busy rates of the memory devices 31 and 32 which are measured by the hierarchical control driver 40. The information about the multiple sets of the IOPSs and busy rates which are acquired periodically by the acquisition unit 11 may be referred to as “sub-pool statistical information” or “statistical information”.

The calculation unit 12 calculates the maximum value of the IOPS in the HDD 31 and the maximum value of the IOPS in the SSD 32. The calculation unit 12 may calculate the maximum value of the IOPS in the HDD 31 on the basis of the IOPSs and busy rates of the HDD 31 that have been acquired by the acquisition unit 11. Also, the calculation unit 12 may calculate the maximum value of the IOPS in the SSD 32 on the basis of the IOPSs and busy rates of the SSD 32 that have been acquired by the acquisition unit 11.

The “maximum value of the IOPS” is an example of a “second number of access times” and represents an IOPS when the performance of the memory devices 31 and 32 reaches a saturated state (e.g., when the busy rates are 80%). The “maximum value of the IOPS” may be referred to as a “maximum performance value”.

The estimation unit 13 estimates the IOPS in the entire storage device 1. The estimation unit 13 may estimate the IOPS in the entire storage device 1 on the basis of the busy rates of the memory devices 31 and 32 as acquired by the acquisition unit 11, and the maximum values of the IOPSs in the memory devices 31 and 32 as calculated by the calculation unit 12.

The “IOPS in the entire storage device 1” is an example of a “third number of access times”.

In a case where the maximum value of the IOPS of the HDD 31 is equal to or smaller than the maximum value of the IOPS of the SSD 32, the estimation unit 13 may calculate the IOPS of the SSD 32 when the IOPS of HDD 31 reaches the maximum value. Then, the estimation unit 13 may calculate the IOPS in the entire storage device 1 by calculating a sum of the maximum value of the IOPS of the HDD 31 and the IOPS of the SSD 32 when the IOPS of the HDD 31 reaches the maximum value.

In a case where the maximum value of the IOPS of the SSD 32 is equal to or smaller than the maximum value of the IOPS of the HDD 31, the estimation unit 13 may calculate the IOPS of the HDD 31 when the IOPS of the SSD 32 reaches the maximum value. Then, the estimation unit 13 may calculate the IOPS in the entire storage device 1 by calculating a sum of the maximum value of the IOPS of the SSD 32 and the IOPS of the HDD 31 when the IOPS of the SSD 32 reaches the maximum value.

The “IOPS of the SSD 32 when the IOPS of the HDD 31 reaches the maximum value” and the “IOPS of the HDD 31 when the IOPS of the SSD 32 reaches the maximum value” are examples of a “fourth number of access times”.

The estimation unit 13 may calculate a first ratio representing a ratio between the IOPS of the HDD 31 and the IOPS of the SSD 32 which have been individually acquired by the acquisition unit 11.

When the maximum value of the IOPS of the HDD 31 is equal to or smaller than the maximum value of the IOPS of the SSD 32, the estimation unit 13 may conform the ratio between the maximum value of the IOPS of the HDD 31 and the IOPS of the SSD 32 when the IOPS of the HDD 31 reaches the maximum value, to the first ratio. Accordingly, the “IOPS of the SSD 32 when the IOPS of the HDD 31 reaches the maximum value” may be calculated.

When the maximum value of the IOPS of the SSD 32 is equal to or smaller than the maximum value of the IOPS of the HDD 31, the estimation unit 13 may conform the ratio between the maximum value of the IOPS of the SSD 32 and the IOPS of the HDD 31 when the IOPS of the SSD 32 reaches the maximum value, to the first ratio. Accordingly, the “IOPS of the HDD 31 when the IOPS of the SSD 32 reaches the maximum value” may be calculated.

The estimation unit 13 may calculate a second ratio representing a ratio between the busy rate of the HDD 31 and the busy rate of the SSD 32 which have been individually acquired by the acquisition unit 11.

When the maximum value of the IOPS of the HDD 31 is equal to or smaller than the maximum value of the IOPS of the SSD 32, the estimation unit 13 may conform the ratio between the busy rate of the HDD 31 and the busy rate of the SSD 32 when the IOPS of the HDD 31 reaches the maximum value, to the second ratio. Accordingly, the “IOPS of the SSD 32 when the IOPS of the HDD 31 reaches the maximum value” may be calculated.

When the maximum value of the IOPS of the SSD 32 is equal to or smaller than the maximum value of the IOPS of the HDD 31, the estimation unit 13 may conform the ratio between the busy rate of the SSD 32 and the busy rate of the HDD 31 when the IOPS of the SSD 32 reaches the maximum value to the second ratio. Accordingly, the “IOPS of the HDD 31 when the IOPS of the SSD 32 reaches the maximum value” may be calculated.

FIG. 3 is a diagram illustrating an exemplary process of estimating a performance in the storage device 1 according to the embodiment. FIG. 4 is a diagram illustrating an exemplary relationship between the IOPS and busy rate in the HDD 31 and the SSD 32 provided in the storage device 1 according to the embodiment.

First, a method of obtaining the graph of FIG. 3 representing a relationship between the IOPS and busy rate in the HDD 31 and the SSD 32 will be described using the graph represented in FIG. 4.

The busy rate linearly increases with respect to the IOPS until the busy rate reaches a specific value (see C1). Meanwhile, when the busy rate exceeds the specific value, the busy rate nonlinearly increases with respect to IOPS (see C2). The busy rate at the time of starting to nonlinearly increase with respect to the IOPS may be referred to as a “proportional limit busy rate” or a “maximum busy rate” (see C3).

As illustrated in FIG. 4, the proportional limit busy rate varies depending on a variation of a workload (which may be referred to as an “access pattern”). Accordingly, the hierarchical control driver 40 periodically measures the IOPSs and busy rates of the memory devices 31 and 32 such that a graph corresponding to a current workload is selected (in other words, derived) from a plurality of workloads (workload1 to workload3 in the example represented in FIG. 4) on the basis of the measurement result. When no variation occurs in the workloads, the same graph is selected. Accordingly, the maximum performance of the memory devices 31 and 32 according to the current workload may be easily estimated.

Since Japanese Laid-Open Patent Publication No. 2011-243043 describes details of the method of obtaining the graph representing the relationship between the IOPS and busy rate, the detailed descriptions thereof will be omitted herein.

The acquisition unit 11 may acquire an actual measurement value for each of the IOPSs and busy rates of the HDD 31 and the SSD 32 which are measured by the hierarchical control driver 40 at the same time. In the example represented in FIG. 3, the IOPS of the HDD 31 is about 600 (times/s), and the busy rate of the HDD 31 is about 48% (see B1). In addition, the IOPS of the SSD 32 is about 2,200 (times/s), and the busy rate of the SSD 32 is about 15.5% (see B2).

The calculation unit 12 may calculate an estimated value for each of the maximum value of the IOPS of the HDD 31 and the maximum value of the IOPS of the SSD 32. In the example represented in FIG. 3, both the maximum busy rates of the HDD 31 and the SSD 32 are set to 80%. The setting of the maximum busy rates may be conducted based on, for example, a pre-input from an operator. The storage device 1 may be operated such that both the busy rates of the memory devices 31 and 32 are equal to or lower than the maximum busy rates.

In the example represented in FIG. 3, the maximum value of the IOPS of the HDD 31 is about 1,000 (times/s) when the busy rate reaches the maximum busy rate of 80% (see B3). In addition, the maximum value of the IOPS of the SSD 32 is about 11,500 (times/s) when the busy rate reaches the maximum value of 80% (see B4).

The estimation unit 13 selects, among the multiple memory devices 31 and 32, the memory device 31 or 32 having the lowest IOPS when the busy rate thereof reaches the maximum busy rate. In the example represented in FIG. 3, the IOPS of the HDD 31 is about 1,000 (times/s) at the maximum busy rate, and the IOPS of the SSD 32 is about 11,500 (times/s) at the maximum busy rate. Accordingly, the estimation unit 13 selects the HDD 31.

Assuming that the load balance of user IO with respect to the memory devices 31 and 32 is maintained, the estimation unit 13 may calculate the IOPS of the unselected memory device 31 or 32 when the IOPS of the selected memory device 31 or 32 reaches the maximum value. In the example represented in FIG. 3, the estimation unit 13 calculates the IOPS of the SSD 32 when the IOPS of the HDD 31 reaches the maximum value. In the illustrated example, the IOPS of the SSD 32 when the IOPS of the HDD 31 reaches the maximum value is about 3,665 (times/s) (see B5).

In FIG. 3, the line connecting the points B1 and B2 to each other and the line connecting the points B3 and B5 to each other are in parallel with each other.

The estimation unit 13 calculates a sum of the maximum value of the IOPS of the selected memory device 31 or 32 and the IOPS of the unselected memory device 31 or 32 when the IOPS of the selected memory device 31 or 32 reaches the maximum value. In the example represented in FIG. 3, the estimation unit 13 calculates a sum of the maximum value of the IOPS of the HDD 31, i.e., about 1,000 (times/s) (see B6), and the IOPS of the SSD 32 when the IOPS of the HDD 31 reaches the maximum value, i.e., about 3,665 (times/s) (see B7). In the illustrated example, the sum is about 4,665 (times/s). Accordingly, the IOPS of the entire storage device 1 is estimated.

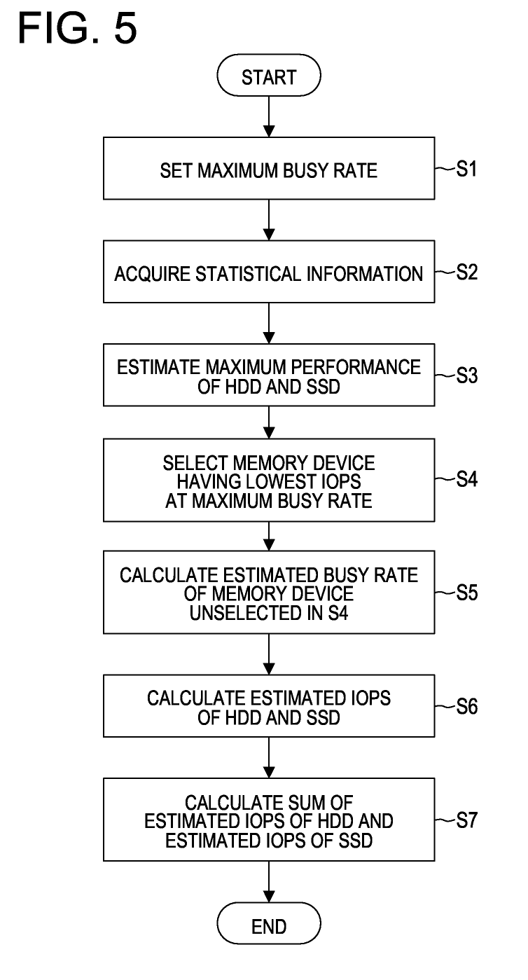

Descriptions will be made on an exemplary process of estimating a performance in the storage device 1 according to the embodiment configured as described above, with reference to the flowchart illustrated in FIG. 5.

The calculation unit 12 may set the maximum busy rate on the basis of, for example, an input from an operator (S1). The information about the set maximum busy rate is stored, for example, in the RAM (not illustrated) included in the memory 20.

The acquisition unit 11 may acquire the IOPSs and busy rates of the HDD 31 and the SSD 32 which are periodically measured by the hierarchical control driver 40 (S2).

The calculation unit 12 may estimate the maximum performance (in other words, the “maximum values of IOPSs”) of the HDD 31 and the SSD 32 (S3).

The estimation unit 13 may select the HDD 31 or the SSD 32 having the lowest IOPS when the busy rate thereof reaches the maximum busy rate, from the multiple HDD 31 and SSD 32 (S4).

The estimation unit 13 calculates an estimated busy rate of the unselected HDD 31 or SSD 32 in S4 (S5). The “estimated busy rate” may be referred to as a “busy rate of the unselected HDD 31 or SSD 32 when the busy rate of the selected HDD 31 or SSD 32 reaches the maximum busy rate”. In addition, the “estimated busy rate of the HDD 31” may be referred to as a “first estimated busy rate”, and the “estimated busy rate of the SSD 32” may be referred to as a “second estimated busy rate”.

The estimation unit 13 may calculate estimated IOPS of each of the HDD 31 and the SSD 32 (S6). The “estimated IOPS” may be referred to as a “maximum value of the IOPS of the selected HDD 31 or SSD 32” or the “IOPS of the unselected HDD 31 or SSD 32 when the IOPS of the selected HDD 31 or SSD 32 reaches the maximum value”. In addition, the “estimated IOPS of the HDD 31” may be referred to as a “first estimated IOPS”, and the “estimated IOPS of the SSD 32” may be referred to as a “second estimated IOPS”.

The estimation unit 13 may calculate a sum of the estimated IOPS of the HDD 31 and the estimated IOPS of the SSD 32 (S7). Accordingly, the IOPS in the entire storage device 1 is estimated, and the process is finished.

For example, the following effects may be achieved by the storage device 1 according to the above-described embodiment.

The calculation unit 12 calculates the maximum values of the IOPSs of the HDD 31 and the SSD 32 on the basis of the IOPSs and busy rates of the memory devices 31 and 32 at a predetermined timing. The estimation unit 13 estimates the IOPS of the storage device 1 on the basis of the busy rates and the maximum values of the IOPSs as calculated by the calculation unit 12.

Accordingly, the system configuration of the storage device 1 including the plurality of memory devices 31 and 32 having different performance characteristics may be easily determined. Specifically, in the storage device 1 including the plurality of memory devices 31 and 32 having different performance characteristics, the system design of the storage device 1 meeting the required input/output performance may be facilitated. Further, by estimating the IOPS of the entire storage device 1, the capacities and the number of the HDDs 31 or the SSDs 32 which are required to meet the required input/output performance may be easily calculated.

When the maximum value of the IOPS of the HDD 31 is equal to or smaller than the maximum value of the IOPS of the SSD 32, the estimation unit 13 calculates the IOPS of the SSD 32 when the IOPS of the HDD 31 reaches the maximum value. Then, the estimation unit 13 calculates the IOPS in the storage device 1 by calculating a sum of the maximum value of the IOPS of the HDD 31 and the IOPS of the SSD 32 when the IOPS of the HDD 31 reaches the maximum value.

Accordingly, since the IOPS of the entire storage device 1 may be estimated on the basis of the maximum value of the IOPS of the HDD 31 having the lower performance value than that of the SSD 32, occurrence of an overload in the storage device 1 due to heavy user IO may be suppressed.

The estimation unit 13 calculates the first ratio representing a ratio between the IOPS of the HDD 31 and the IOPS of the SSD 32. Then, the estimation unit 13 sets a value of the IOPS of the SSD 32 when the IOPS of the HDD 31 reaches the maximum value in order to conform the ratio between the maximum value of the IOPS of the HDD 31 and the IOPS of the SSD 32 when the IOPS of HDD 31 reaches the maximum value, to the first ratio.

The estimation unit 13 calculates the second ratio representing a ratio between the busy rate of the HDD 31 and the busy rate of the SSD 32. Then, the estimation unit 13 sets a value of the busy rate of the SSD 32 when the IOPS of the HDD 31 reaches the maximum value in order to conform the ratio between the busy rate of the HDD 31 and the busy rate of the SSD 32 when the IOPS of the HDD 31 reaches the maximum value, to the second ratio.

As a result, the IOPS in the entire storage device 1 may be estimated in consideration of the load balance on the basis of the ratio of the IOPS or the busy rate between the HDD 31 and the SSD 32 as actual measurement values.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A storage device, comprising:
a first memory;
a second memory having a different performance characteristic from that of the first memory; and
a processor coupled to the first and second memories and the processor configured to
calculate a second number of access times with respect to each of the first and second memories on basis of a first busy rate and a first number of access times with respect to each of the first and second memories, the first busy rate representing a busy rate at a predetermined timing, the first number of access times representing a number of access times per unit time at the predetermined timing, the second number of access times representing a maximum value of the number of access times per unit time, and
estimate a third number of access times on basis of the first busy rate and the second number of access times of each of the first and second memories, the third number of access times representing a number of access times per unit time with respect to the storage device.

2. The storage device according to claim 1, wherein
the processor is configured to
calculate a fourth number of access times in a case where the second number of access times with respect to the first memory is equal to or lower than the second number of access times with respect to the second memory, the fourth number of access times representing a number of access times per unit time with respect to the second memory when a number of access times per unit time with respect to the first memory reaches the second number of access times, and
calculate, to estimate the third number of access times, a sum of the second number of access times with respect to the first memory and the fourth number of access times.

3. The storage device according to claim 2, wherein
the processor is configured to
calculate a first ratio representing a ratio between the first number of access times with respect to the first memory and the first number of access times with respect to the second memory, and
conform, to calculate the fourth number of access times, a ratio between the second number of access times with respect to the first memory and the fourth number of access times to the first ratio.

4. The storage device according to claim 2, wherein
the processor is configured to
calculate a first ratio representing a ratio between the first busy rate of the first memory and the first busy rate of the second memory, and
conform a second ratio to the first ratio to calculate the fourth number of access times, the second ratio representing a ratio between a busy rate of the first memory and a busy rate of the second memory when a number of access times per unit time with respect to the first memory reaches the second number of access times.

5. A non-transitory computer-readable recording medium having stored therein a program that causes a computer to execute a process, the process comprising:
calculating a second number of access times with respect to each of first and second memories on basis of a first busy rate and a first number of access times with respect to each of the first and second memories, the first and second memories having different performance characteristics, the first busy rate representing a busy rate at a predetermined timing, the first number of access times representing a number of access times per unit time at the predetermined timing, the second number of access times representing a maximum value of the number of access times per unit time; and
estimating a third number of access times on basis of the first busy rate and the second number of access times of each of the first and second memories, the third number of access times representing a number of access times per unit time with respect to the storage device.

6. The non-transitory computer-readable recording medium according to claim 5, the process further comprising:
calculating a fourth number of access times in a case where the second number of access times with respect to the first memory is equal to or lower than the second number of access times with respect to the second memory, the fourth number of access times representing a number of access times per unit time with respect to the second memory when a number of access times per unit time with respect to the first memory reaches the second number of access times; and
calculating, to estimate the third number of access times, a sum of the second number of access times with respect to the first memory and the fourth number of access times.

7. The non-transitory computer-readable recording medium according to claim 6, the process further comprising:
calculating a first ratio representing a ratio between the first number of access times with respect to the first memory and the first number of access times with respect to the second memory; and
conforming, to calculate the fourth number of access times, a ratio between the second number of access times with respect to the first memory and the fourth number of access times to the first ratio.

8. The non-transitory computer-readable recording medium according to claim 6, the process further comprising:
calculating a first ratio representing a ratio between the first busy rate of the first memory and the first busy rate of the second memory; and
conforming a second ratio to the first ratio to calculate the fourth number of access times, the second ratio representing a ratio between a busy rate of the first memory and a busy rate of the second memory when a number of access times per unit time with respect to the first memory reaches the second number of access times.

9. A method of estimating a performance of a storage device, the method comprising:
calculating, by a computer, a second number of access times with respect to each of first and second memories on basis of a first busy rate and a first number of access times with respect to each of the first and second memories, the first and second memories having different performance characteristics, the first busy rate representing a busy rate at a predetermined timing, the first number of access times representing a number of access times per unit time at the predetermined timing, the second number of access times representing a maximum value of the number of access times per unit time; and
estimating a third number of access times on basis of the first busy rate and the second number of access times of each of the first and second memories, the third number of access times representing a number of access times per unit time with respect to the storage device.

10. The method according to claim 9, further comprising:
calculating a fourth number of access times in a case where the second number of access times with respect to the first memory is equal to or lower than the second number of access times with respect to the second memory, the fourth number of access times representing a number of access times per unit time with respect to the second memory when a number of access times per unit time with respect to the first memory reaches the second number of access times; and
calculating, to estimate the third number of access times, a sum of the second number of access times with respect to the first memory and the fourth number of access times.

11. The method according to claim 10, further comprising:
calculating a first ratio representing a ratio between the first number of access times with respect to the first memory and the first number of access times with respect to the second memory; and
conforming, to calculate the fourth number of access times, a ratio between the second number of access times with respect to the first memory and the fourth number of access times to the first ratio.

12. The method according to claim 10, further comprising:
calculating a first ratio representing a ratio between the first busy rate of the first memory and the first busy rate of the second memory; and
conforming a second ratio to the first ratio to calculate the fourth number of access times, the second ratio representing a ratio between a busy rate of the first memory and a busy rate of the second memory when a number of access times per unit time with respect to the first memory reaches the second number of access times.
